(19) United States
(12) Patent Application Publication
(10) Pub. No.: US 2017/0200138 A1
(43) Pub. Date: Jul. 13, 2017

(54) TRANSACTION MANAGEMENT SYSTEM AND METHOD

(71) Applicant: Shoal Limited, West Yorkshire (GB)

(72) Inventors: Oliver George Squires, West Yorkshire (GB); Christopher David Salkeld, West Yorkshire (GB); Andrew William Salkeld, West Yorkshire (GB)

(21) Appl. No.: 15/057,905

(22) Filed: Mar. 1, 2016

(30) Foreign Application Priority Data
Jan. 13, 2016 (GB) 1600649.6

(51) Int. Cl. G06Q 20/10; G06Q 30/02

(52) U.S. Cl. CPC G06Q 20/10; G06Q 30/0283

(57) ABSTRACT

A transaction management system comprises a communication interface; a storage unit; a quantity determination unit and an account update unit. The system receives transaction requests for products via the communication interface, the quantity determination unit determines if the number of transaction requests received for a product exceeds a predetermined value, and if so the account update unit updates account data of one or more users that have previously made transaction requests for the product. Accordingly, historic account data can be updated based on the number of transaction requests received.

### FIELD

This invention relates to a transaction management system and method.

### BACKGROUND

Online marketplaces or e-commerce platforms are routinely provided to facilitate the remote purchase of items by customers. Items are typically browsed by a user, who then adds desired items to a notional shopping cart. Once all the items desired by the user have been selected and added to the cart, the user remotely purchases the items, for example by credit card.

Whilst this general sort of platform operates adequately for straightforward purchases made by individuals, transactions between large businesses for the purchase of services and resources are frequently more complex, and may involve the issuance of discounts, the offering of lending facilities, the issuance of credit notes and various schemes and incentives for the purchase of the items that are not catered for in normal online marketplace systems.

The implementation, management and operation of complex transactions of this nature is arduous, and difficulties arise in ensuring that the parameters and logic behind the transactions, application of discounts or issuance of credit notes is apparent to both sellers and buyers.

It is an object of this invention to address the above-mentioned difficulties, and any other difficulties that would be apparent to the skilled reader from the description herein. It is a further object of this invention to provide a transaction management system that facilitates financial transactions in a transparent and easily configurable manner.

### SUMMARY

According to the present invention there is provided an apparatus and method as set forth in the appended claims. Other features of the invention will be apparent from the dependent claims, and the description which follows.

According to a first aspect of the invention, there is provided a transaction management system comprising:

a communication interface operable to receive a plurality of transaction requests for a product;

a storage unit operable to store the plurality of transaction requests and account data of a user making each respective transaction request;

a quantity determination unit operable to determine if the number of transaction requests received exceeds a predetermined value; and

an account update unit operable to update the account data of one or more users that have previously made transaction requests for the product when the quantity determination unit determines that the predetermined value has been exceeded.

The storage unit may comprise a product storage area operable to store product data pertaining to the products offered for sale. The product data may comprise one or more of a description of the product, a quantity of items of the product that are available, and price curve data. The price curve data may relate a quantity of items of a product sold to a price. The price curve data may comprise a series of quantity ranges, each range being associated with a price. Accordingly, the price at which an item is to be sold upon the receipt of a transaction request can be established from the price curve data.

One, or more, of the communication interface, the storage unit, the quantity determination unit and the account update unit may be located remotely from the other units.

The quantity determination unit may be operable to determine if the number of transaction requests exceeds a limit of one of the quantity ranges. If receipt of a new transaction request results in the limit of one of the ranges being exceeded, the quantity determination unit may be operable to set the price of the item to the price corresponding to a quantity range in which the number of transaction requests falls.

The price curve data may include time data. The time data may indicate a range of times for which the price curve data applies. The time data may comprise a time-offset, after which any price change may no longer be retrospectively applied. The account update unit may determine whether to update the account data based on the time data. The account update unit may only update the account data if a present date and time is within the range of times. The account update unit may only update the account data if the date and time at which the previously made transaction request occurred is within the range of times. The account update unit may only update the account data if the previously made transaction occurred within the time offset.

The storage unit may comprise an account data storage area operable to store user account data. The account data storage area may be operable to store seller account data. The user and/or seller account data may include identity information, identifying the user and/or seller. The account data may include an account balance, reflecting the available funds of the user and/or seller. The storage unit may comprise a transaction data area, operable to store data relating to received transaction requests. The transaction data may comprise one or more of: identity information identifying the product, a date and time at which the transaction has been carried out, the identity of the user and the seller, and the price at which the item has been sold.

The communication unit may be operable to receive the product data from a selling device or selling system.

The quantity determination unit may be configured to determine if the number of transaction requests exceeds a limit of one of the quantity ranges. The quantity determination unit may be operable to determine the number of transaction requests received by querying the transaction data area based on the identity information identifying the product. The quantity determination unit may maintain a cumulative frequency of items sold for each product, and may determine if the cumulative frequency exceeds the predetermined value, preferably the limit of one of the quantity ranges. The quantity determination unit may be configured to carry out the determination each time a new transaction request is received by the communication unit. The quantity determination unit may be configured to carry out the determination periodically, for example once per hour, once per day or once per week.

The account update unit may be operable to calculate an update offset between a current quantity range and the next quantity range. The update offset may be a price differential. The account update unit may be operable to update the balance. The account update unit may be operable to update the account data to include discount data.

The account update unit may be configured to retrieve details of each previous transaction of the product, preferably by querying the transaction data area. The account update unit may be operable to update the account data, preferably the account balance, of a user associated with each previous transaction of the product, preferably using the update offset.

According to a second aspect of the invention, there is provided a computer-implemented transaction management method, comprising the steps of: receiving, via a communication network, a transaction request for a product; determining if the number of transaction requests received exceeds a predetermined value, and updating account data of one or more users that have previously made transaction requests for the product when it is determined that the predetermined value has been exceeded.

Further preferred features of the components required in the method of the second aspect are defined hereinabove in relation to the first aspect and may be combined in any combination.

According to a third aspect of the invention, there is provided a computer-readable medium having instructions recorded thereon which, when executed, cause a computer device to perform the method of the second aspect.

Further preferred features of the components required in the computer-readable medium of the third aspect are defined hereinabove in relation to the first and second aspects and may be combined in any combination.

### BRIEF DESCRIPTION OF DRAWINGS

For a better understanding of the invention, and to show how embodiments of the same may be carried into effect, reference will now be made, by way of example, to the accompanying diagrammatic drawings in which:

FIG. 1 is a schematic block diagram of a transaction management system in accordance with an example of the invention;

FIG. 2 is a schematic illustration of price curve data;

FIG. 3 is a schematic block diagram of the storage unit of the transaction management system of FIG. 1, and

FIG. 4 is a flowchart of a transaction management method in accordance with an example of the invention.

In the drawings, corresponding reference characters indicate corresponding components. The skilled person will appreciate that elements in the figures are illustrated for simplicity and clarity and have not necessarily been drawn to scale. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

### DESCRIPTION OF EMBODIMENTS

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

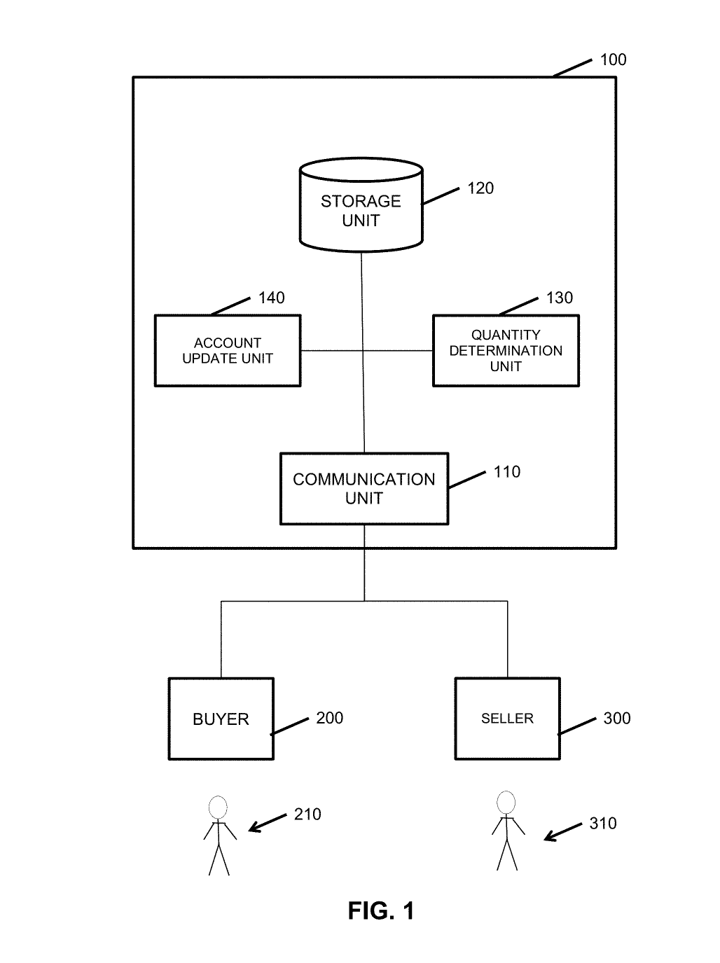

FIG. 1 shows an example transaction management system 100. The transaction management system 100 comprises a communication unit 110, a storage unit 120, a quantity determination unit 130, and an account update unit 140.

The communication unit 110 is operable to manage communications between the system 100 and external computing devices over a network. The network may take any suitable form, including one or more wired and/or wireless communication links, as will be familiar to those skilled in the art.

The communication unit 110 is configured communicate with one or more purchasing devices 200, operated by users 210 seeking to purchase products via the transaction management system 100. The purchasing device 200 may be any suitable computing device, such as a personal computer, smart phone, tablet computer or the like. In one example, the communication unit 110 is operable to communicate with the purchasing device 200 via HTTP, for example by providing a web-based interface. However, it will be understood that the communication unit could use any suitable communication protocol.

For clarity, hereinafter the term “product” refers generally to the particular type or model of goods offered, and the term “item” refers to a particular instance of that type or model.

The communication unit 110 is operable to receive a transaction request from the purchasing device 200, indicating that the user 210 wishes to purchase an item via the transaction management system 100.

In one example, the communication unit 110 is also operable to communicate with one or more selling devices 300, operated by users 310 offering goods or services for sale via the transaction management system 100. The selling device 300 may be any suitable computing device, such as a personal computer, smart phone, tablet computer or the like. In one example, the communication unit 110 is operable to communicate with the selling device 300 via HTTP, for example by providing a web-based interface. However, it will be understood that the communication unit could use any suitable communication protocol.

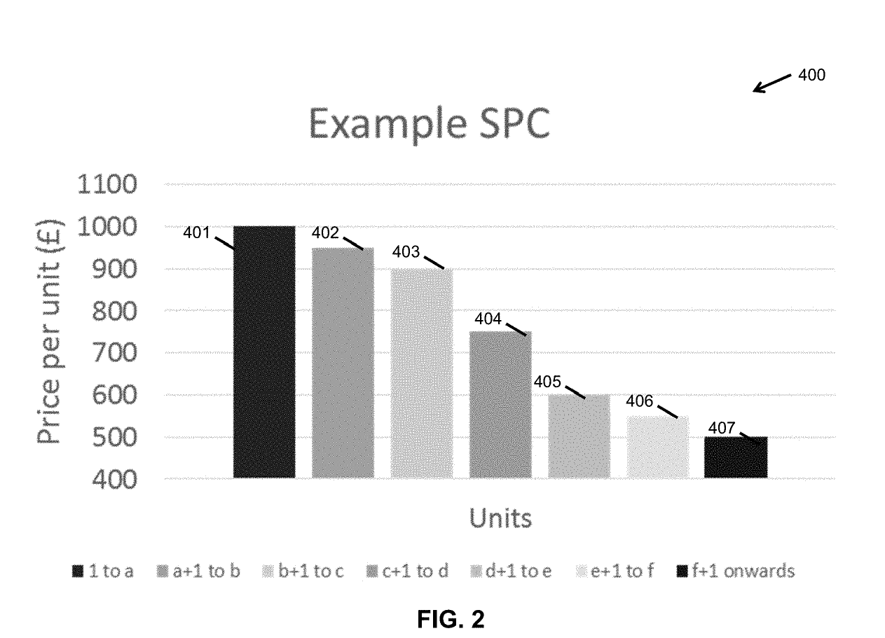

In one example, the communication unit 110 receives product data pertaining to the products offered for sale from the selling devices 300. In one example, the product data comprises a description of the product, a quantity of items of the product that are available, and price curve data 400, which will be described in detail below with reference to FIG. 2.

The price curve data 400 relates a quantity of items of a product sold to a price. Particularly, the price curve data 400 comprises a series of quantity ranges 401-407, each range with a given price. For example, in FIG. 2, a first quantity range 401 indicates that the range of items 1 to a are each to be sold for £1000, a second quantity range 402 indicates that the items a+1 to b are to be sold at £950, a third quantity range 402 indicates that the items b+1 to c are to be sold at £900, and so on. Accordingly, the price at which an item is to be sold upon the receipt of a transaction request can be established from the price curve data 400.

It will be understood that the price curve data may include more or fewer ranges than the 7 ranges 401-407 indicated on FIG. 2. It will be further understood that the values a-f and the prices associated with the ranges may be varied according to the desires of the seller.

In one example, the price curve data 400 further includes time data. In one example, the time data indicates a limited range of dates/times for which the price curve data 400 applies. In a further example, the time data indicates a time-offset, after which any price change may no longer be retrospectively applied.

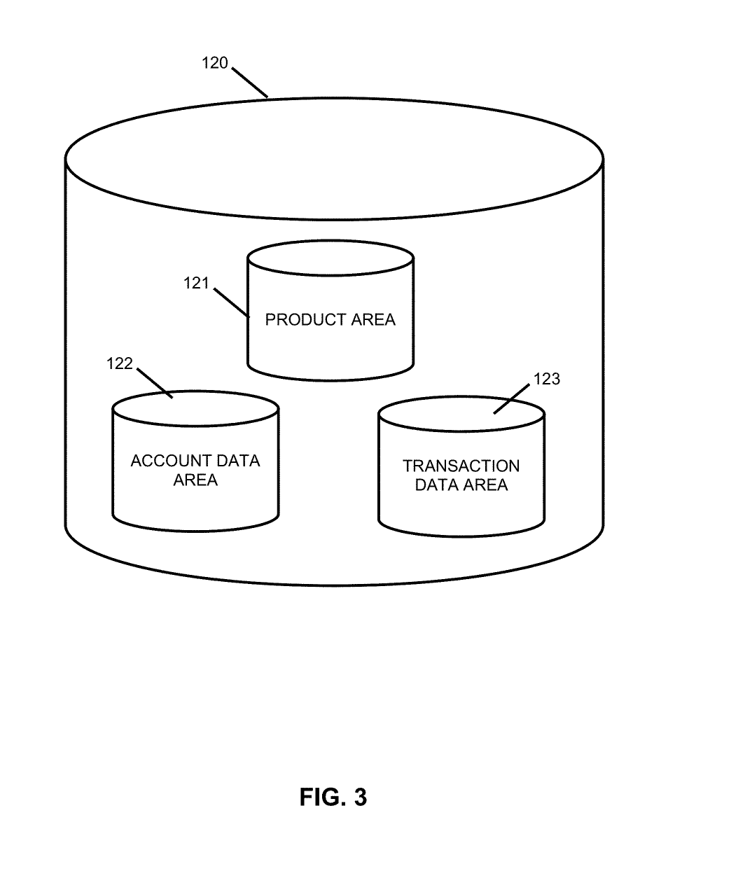

The storage unit 120 is configured to store data required for the operation of the transaction management system 100, and is shown in more detail in FIG. 3. In one example, the storage unit 120 has a product storage area 121, operable to store the product data received from the selling device 300. In one example, the storage unit 120 has an account data storage area 122, operable to store account data of both buyers 210 and sellers 310. In one example, the account data includes identity information, identifying each respective buyer 210 or seller 220. In one example, the account data includes an account balance, reflecting the available funds of the buyer 210 and/or seller 310. In one example, the storage unit 120 comprises a transaction data area 123. The transaction data area 123 stores data relating to each transaction request that has been received by the system 100. In one example, the transaction data comprises identity information identifying the product, a date and time at which the transaction has been carried out, the identity of the seller and buyer and the price at which the item has been sold.

The quantity determination unit 130 is configured to determine if the number of transaction requests received for a particular product exceeds a given threshold. In one example, the quantity determination unit 130 is configured to determine if the cumulative number of transaction requests exceeds the limit of one of the quantity ranges of the price curve data 400 for that product. In one example, the quantity determination unit 130 determines the number of transaction requests received by querying the transaction data area 123 based on the product details. In another example, the quantity determination unit 130 maintains a cumulative frequency for each product, and determines if the cumulative frequency exceeds the limit of one of the quantity ranges 401-407 of the price curve data 400 for that product.

In one example, the quantity determination unit 130 is configured to carry out the determination each time a new transaction request is received by the communication unit 110. In this example, if the new transaction request results in the threshold being exceeded, the quantity determination unit 130 is operable to facilitate the sale of the item at the price corresponding to the new quantity range 401.

In one example, the quantity determination unit 130 is configured to carry out the determination periodically, for example once per hour, once per day or once per week.

The account update unit 140 is configured to update the account data area 122 when the quantity determination unit 130 determines that the threshold has been exceeded. In particular, the account update unit 140 is operable to query the product data area 121 to retrieve the price curve data, so as to calculate the price differential between the previous quantity range and the present quantity range. For example, if the quantity determination unit 130 has determined that the new quantity range is range 402, the price associated with this new range 402 is deducted from the price associated with the previous range 401, to give an update offset.

The account update unit 140 is further configured to query the transaction data area 123 to retrieve details of each previous transaction of the product. For each of these transactions, the account update unit 140 updates the account balance of the associated user held in the account data area 122, using the update offset. For example, if the update offset between range 401 and range 402 is £50, each previous user that has purchased the product is credited to the value of the update offset. In one example, the account update unit 140 is configured to generate a credit note detailing the application of each respective update offset. The credit note may take the form of a suitable text document. In one example, the communication unit 11 is operable to transmit the credit note to the buyer and seller, so as to provide a record of the application of the offset.

In one example, the account update unit 140 determines whether the update offset is to be applied based on the time data. In an example where the time data indicates a range of dates/times at which the curve data 400 applies, the update only occurs if the present date and time is within the range. In another example, the update only occurs if the date and time at which the previous transaction occurred is within the range. In an example where the time data indicates a time offset, the update only occurs if the transaction occurred within the time offset, e.g. within the last 7 days, or last month.

It will be further understood that the account update unit 140 may, in addition to or instead of applying the update offset, perform further updates to the account data of the associated user. For example, the account update unit 140 may update the account data to include discount data, relating to a discount to be applied against future purchases. The discount data may comprise information regarding the value of the discount, an indication of which sellers 310 will accept the discount, and information indicating any limitation as to the products the discount may be applied to.

In use, a seller 310 provides product data pertaining to a product to the system 100 via the communication unit 110. The product data is stored in the storage unit 120. In particular, the price curve data 400 associated with the product is stored in the product data area 121.

Subsequently, buyers 210 submit transaction requests via the communication unit 110. The items are sold at the price indicated by the price curve data 400. The transactions are completed, and the details thereof are stored in the transaction data area 123.

The quantity determination unit 130 then determines if the number of transaction requests for the product has exceeded a predetermined threshold. In one example, the quantity determination unit 130 queries the price curve data held in the product data area 121 to establish whether the number of transaction requests has exceeded the limit of a quantity range 401-407 for that product. In one example, the quantity determination unit 130 carries out the determination as part of each transaction. In one example, the determination is carried out periodically.

In the event that the quantity determination unit 130 does determine that the number of transaction requests has exceeded the limit of the relevant quantity range 401-407, the account update unit 140 calculates the update offset resulting from the change in quantity range 401-407. The account update unit 140 then retrieves historical transaction data corresponding to the product from the transaction data area 123, and applies the update offset to the user account stored in the account area 122 associated with each historical transaction. In one example, the application of the update offset is limited based on time data associated with the price curve data 400.

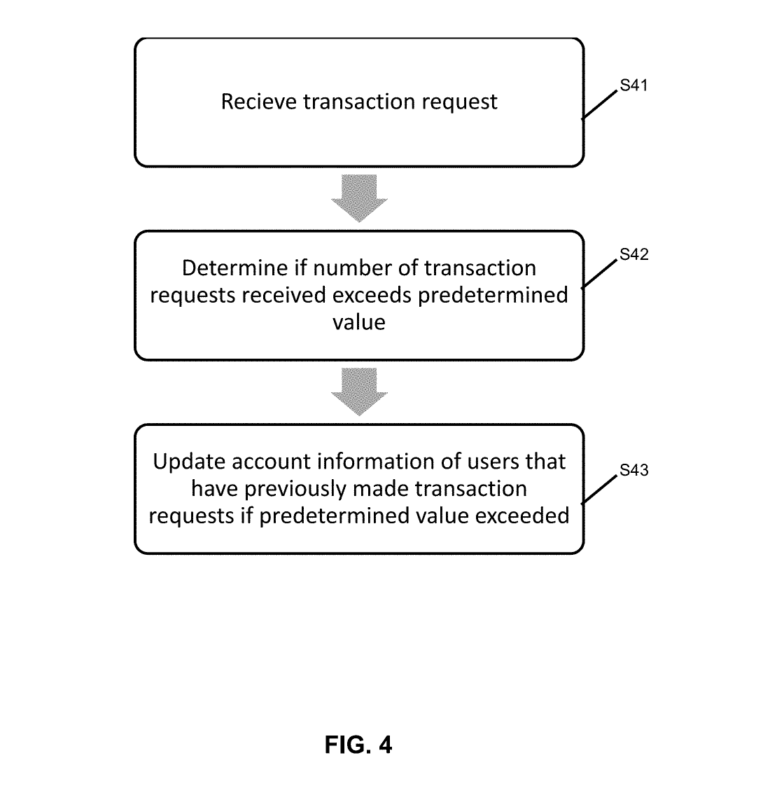

FIG. 4 is a schematic flowchart of an example transaction management method. The method comprises a first step S41 of receiving a transaction request from a buyer. The method comprises a second step S42 of determining if the number of transaction requests received exceeds a predetermined value. The method comprises a third step S43 of updating account information of users that have previously made transaction requests, if the predetermined value has been exceeded. Further steps may be included in the method, as have been described herein.

The above-described systems and methods may advantageously provide a means of conveniently managing financial transactions. In particular, the systems and methods provide a convenient means of specifying and implementing a quantity-related discount schedule. Accordingly, a simple and intuitive system is provided that allows sellers to offer and configure complex transactions not provided for in prior art marketplaces with ease, and with minimal training.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A transaction management system comprising:
a communication interface operable to receive a plurality of transaction requests for a product;
a storage unit operable to store the plurality of transaction requests and account data of a user making each respective transaction request;
a quantity determination unit operable to determine if the number of transaction requests received exceeds a predetermined value; and
an account update unit operable to update the account data of one or more users that have previously made transaction requests for the product when the quantity determination unit determines that the predetermined value has been exceeded.

2. The system of claim 1, wherein the storage unit is operable to store product data pertaining to the products offered for sale, the product data comprising price curve data operable to relate a quantity of items of a product sold to a price.

3. The system of claim 2, wherein the price curve data comprises a series of quantity ranges, each range being associated with a respective price, and wherein the quantity determination unit is configured to determine if the number of transaction requests exceeds a limit of one of the quantity ranges.

4. The system of claim 3, wherein, if receipt of a new transaction request results in the number of transaction requests exceeding the limit of one of the quantity ranges, the quantity determination unit is operable to set the price of the item to the price corresponding to the quantity range in which the number of transaction requests falls.

5. The system of claim 2, wherein the price curve data includes time data indicating a range of times for which the price curve data applies.

6. The system of claim 5, wherein the account update unit is operable to update the account data if the present date and time is within the range of times.

7. The system of claim 5, wherein the account update unit is operable to update the account data if a date and time at which the previously made transaction request occurred is within the range of times.

8. The system of claim 5, wherein the time data comprises a time-offset, and the account update unit is operable to update the account information if the previously made transaction request occurred within the time offset.

9. The system of claim 3, wherein the account update unit is operable to calculate an update offset between a current quantity range and the next quantity range, and update the account data using the update offset.

10. The system of claim 2, wherein the communication unit is operable to receive the product data from a selling device or selling system.

11. The system of claim 1, wherein the account data includes an account balance, reflecting the available funds of the user, and wherein the account update unit is operable to update the balance.

12. The system of claim 1, wherein the storage unit comprises a transaction data area, operable to store transaction data relating to received transaction requests, the transaction data comprising identity information identifying the product, and
wherein the quantity determination unit is operable to determine the number of transaction requests received by querying the transaction data area based on the identity information identifying the product.

13. The system of claim 1, wherein the quantity determination unit maintains a cumulative frequency of items sold for each product, and is operable to determine if the cumulative frequency exceeds the predetermined value.

14. The system of claim 1, wherein the quantity determination unit is configured to carry out the determination each time a new transaction request is received by the communication unit.

15. The system of claim 1, wherein the quantity determination unit is configured to carry out the determination periodically.

16. A computer-implemented transaction management method, comprising the steps of:
receiving, via a communication network, a transaction request for a product;
determining if the number of transaction requests received exceeds a predetermined value, and
updating account data of one or more users that have previously made transaction requests for the product when it is determined that the predetermined value has been exceeded.

17. The method of claim 16, comprising storing product data pertaining to the products offered for sale, the product data comprising price curve data relating a quantity of items of a product sold to a price.

18. The method of claim 17, wherein the price curve data comprises a series of quantity ranges, each range being associated with a respective price, and the determining comprises determining if the number of transaction requests exceeds a limit of one of the quantity ranges.

19. The method of claim 18, further comprising calculating an update offset between a current quantity range and the next quantity range, and updating the account data using the update offset.

20. A computer-readable medium having instructions recorded thereon which, when executed, cause a computer device to perform the method, comprising:
receiving, via a communication network, a transaction request for a product;
determining if the number of transaction requests received exceeds a predetermined value, and
updating account data of one or more users that have previously made transaction requests for the product when it is determined that the predetermined value has been exceeded.
